(19) United States
(12) Patent Application Publication
(10) Pub. No.: US 2013/0007042 A1
(43) Pub. Date: Jan. 3, 2013

(54) SYSTEMS AND METHODS FOR DISTRIBUTING MEDIA ASSETS BASED ON IMAGES

(75) Inventors: Walter R. Klappert, Los Angeles, CA (US); Daniel T. Ward, Los Angeles, CA (US)

(73) Assignee: UNITED VIDEO PROPERTIES, INC., Santa Clara, CA (US)

(21) Appl. No.: 13/173,379

(22) Filed: Jun. 30, 2011

(51) Int. Cl. G06F 15/16; G06F 17/30

(52) U.S. Cl. 707/769; 709/217; 707/E17.108

(57) ABSTRACT

Systems and methods are provided for providing a user with efficient and effective intelligent control of media assets distributed to the user's media devices. The user may control distributed media assets by sending captured images to the media delivery system. Features identified in the captured images are used to select media assets that are likely to be of interest to the user. The selected relevant media assets are distributed to one or more media devices for presentation to the user. The distributed media assets may be intelligently selected from the media assets available through the user's primary media delivery system, or may be supplementary media assets not available through the user's primary media delivery system.

### BACKGROUND OF THE INVENTION

The present invention relates generally to providing media assets to a user, and more particularly, to controlling media assets distributed through a media delivery system using images captured by a user.

As mobile devices become more robust and powerful, users are being provided with remote control and functionality on many platforms for which such control was not previously available. For media delivery systems, users can now access, schedule, and even view media from their in-home media delivery system on any mobile device over a communications network. For example, users can schedule recordings on their in-home devices using a cellular phone with a mobile data connection. Users can also access and view media from their in-home delivery system on a remote laptop computer over an Internet connection.

Interfaces used to provide users with remote control of a media delivery system may often hamper the user's ability to quickly and efficiently select media assets that they are interested in. A user may have to sift through many media assets and advertisements that are of no interest to them to find desired media.

In some instances, a user may not even have enough information to find the media they are looking for. For example, the media that the user desires may be related to something the user sees during a normal day and may not be able to exactly identify. For example, if a user sees a famous actor walking down the street, the user may recognize the actor but not remember the actor's name. If the user wishes to access his or her media delivery system before they forget about the actor, he or she may have trouble using a mobile device to search for media assets containing the actor without knowing the actor's name.

Accordingly, it would be desirable to provide a user with efficient and effective remote control of media assets distributed to the user's media devices.

### SUMMARY OF THE INVENTION

In view of the foregoing, systems and methods for providing a user with efficient and effective remote control of media assets distributed to the user's media devices are provided.

The present invention allows a user to remotely control media distributed to one or more of the user's media devices by capturing images that are of interest to the user. With the integration of cameras into many common mobile devices, capturing images of interest is relatively simple for a user and can be useful when a user desires to locate media based on something the user sees. The present invention allows for remote control of distributed media without creating the burden caused by prior art systems that require explicit information identifying the desired media assets to be entered manually by a user. Features identified in images received from a user are used to select media assets that are relevant to the user, and the selected media assets are distributed by the system of the present invention to one or more media devices for the user's consumption.

In some embodiments, a system of the present invention may be the primary source of media distributed to a user. The system may include collections of all media assets that are available to a user through the user's media delivery service, and may search all of the assets to provide relevant media to a user. The system may distribute media regularly to the user, and may integrate selected relevant media sources into normally distributed media in response to receiving an image from the user and selecting relevant media assets based on the image.

In some embodiments, the system of the present invention may be the secondary source of media distributed to a user. The system may be integrated into an existing standalone media delivery service. In addition to media sources available through the service, the system of the present invention may provide access to additional media assets not typically available through the existing service to select media assets relevant to a user. The system may thus improve media distributed by the existing service both by intelligently selecting relevant media assets available through the existing service and by distributing additional media assets that are not available through the existing service. The media distributed may be coordinated and distributed by both the system of the present invention and components of the existing media delivery service, or may be coordinated and distributed directly by the system.

Further features of the invention, its nature, and various advantages will be more apparent from the accompanying drawings and the following detailed description of the preferred embodiments.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative distribution of media assets based on an image captured by a user in accordance with an embodiment of the present invention;

FIG. 2 shows an illustrative user device in accordance with an embodiment of the present invention;

FIG. 3 shows an illustrative media center in accordance with an embodiment of the present invention;

FIG. 4 shows an illustrative media delivery system in accordance with an embodiment of the present invention;

FIG. 5 shows an illustrative media delivery system employed as a secondary media distribution source in accordance with an embodiment of the present invention;

FIG. 6 shows an illustrative media device screen for presenting selected relevant media assets to a user in accordance with an embodiment of the present invention;

FIG. 7 shows an illustrative media device screen for presenting a summary of captured images and selected relevant media assets to a user in accordance with an embodiment of the present invention;

FIG. 8 is a flow chart of illustrative steps involved in distributing media assets to a user's media devices based on images received from the user in accordance with an embodiment of the present invention; and

FIG. 9 is a flow chart of illustrative steps involved in identifying features of an image received at a media center to be used to control media assets distributed to a user's media devices in accordance with an embodiment of the present invention.

### DETAILED DESCRIPTION OF EMBODIMENTS

The number of media assets available to users in any given media delivery system may be substantial. Media assets available to a user may include conventional television media (provided via traditional broadcast, cable, satellite, Internet, or other means), as well as pay-per-view media, on-demand media (as in video-on-demand (VOD) systems), Internet media (e.g., streaming media, downloadable media, Webcasts, podcasts, etc.), recorded media (e.g., on a digital video recorder (DVR) system), advertisements, and other types of media or video content. The term multimedia is defined herein as media and content that utilizes at least two different content forms, such as text, audio, still images, animation, video, and interactivity content forms. Multimedia content may be recorded and played, displayed, or accessed by information content processing devices, such as computerized and electronic devices, but may also be part of a live performance. It should be understood that the invention embodiments that are described in relation to media or media assets are applicable to any types of media, such as video, audio and/or multimedia.

The present invention provides media delivery systems and methods for facilitating remote control of media distributed through a user's media delivery system. A media delivery system of the present invention receives images captured by a user that are used to control media distributed to one or more of the user's media devices. The user may capture images at any time, for example, with a mobile device, and send the images to the media delivery system to control media distributed to one or more of the user's media devices that are remotely located. The media delivery system analyzes the images to identify features of the image. The identified features are then used to select media assets that are distributed to one or more media devices for the user's consumption.

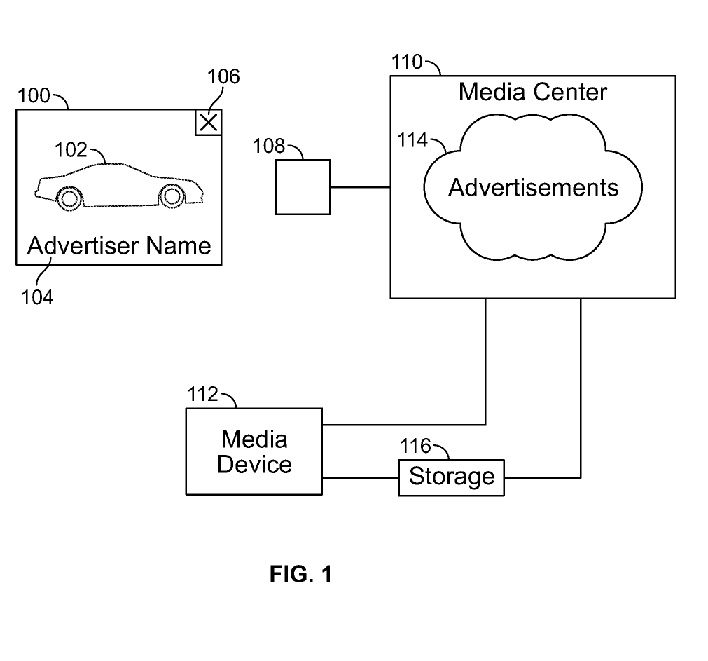

An illustrative embodiment of the distribution of media assets in accordance with the present invention is shown in FIG. 1. For the purpose of illustration and not limitation, the process is described herein with respect to an advertisement distributed to a user in response to an image of a billboard captured by the user, but the process may be applied using any other suitable captured image or distributed media.

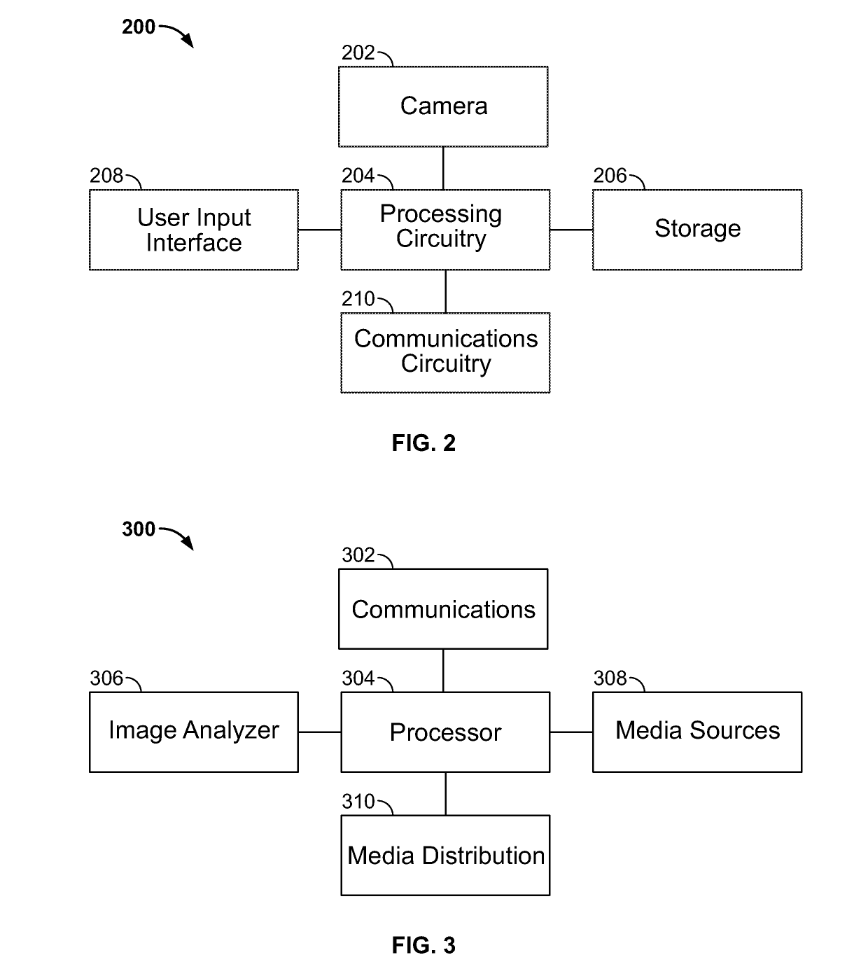

Billboard 100 of FIG. 1 is an advertisement for car 102. In addition to a picture of car 102, billboard 100 includes advertiser name 104 indicating the manufacturer of the car and logo 106 associated with the car manufacturer. A user passing by billboard 100 may be interested in car 102 or the manufacturer of car 102 and may capture an image of billboard 100 with user device 108. User device 108 may be a digital camera, video camera, film camera, mobile telephone, smartphone, personal computer, or any other suitable user device capable of capturing images. User device 108 may have substantially the same functionality discussed below with respect to user device 200 of FIG. 2.

In addition to a captured image, user device 108 may also receive user input related to the billboard. For example, if the user knows the model name of the advertised car, he or she may input the model name to facilitate an accurate identification of the car. In addition to user input, user device 108 may also automatically obtain additional data to be sent with the image, such as the location of user device 108 when the image of billboard 100 is captured if, for example, user device 108 includes an integrated location sensor, such as a GPS sensor.

The captured image and any additional data is sent from user device 108 to media center 110 for analysis. User device 108 may also send information with the image to media center 110 that identifies the user or the user device sending the picture. The identifying information may include a username, account number, authorization information (e.g., a password), identification number, device name, or any other suitable information. Media center 110 may use the information to identify the user or the user device sending an image and associate the received image with a user account. The user account may be used to indicate the user's preferences for media distribution or to identify the user's devices to which media is distributed.

Media center 110 processes the received images and identifies features of the image to use in selecting media assets to distribute to the user. Media center 110 may have substantially the same functionality discussed below with respect to media center 300 of FIG. 3. Media center 110 processes the captured image received from user device 108 to identify car 102, advertiser name 104, and logo 106. Media center 110 may be capable of identifying the make and model of car 102, or may only be capable of creating descriptive identifiers of car 102, such as identifying the object as a car or indicating the color of the car. Media center 110 may be capable of identifying advertiser name 104 by using optical character recognition (OCR) or similar technology to read the text in the billboard. Media center 110 may be capable of identifying logo 106 and the company associated with logo 106 through an image-based search by comparing the logo to a set of logos for which associated companies are known.

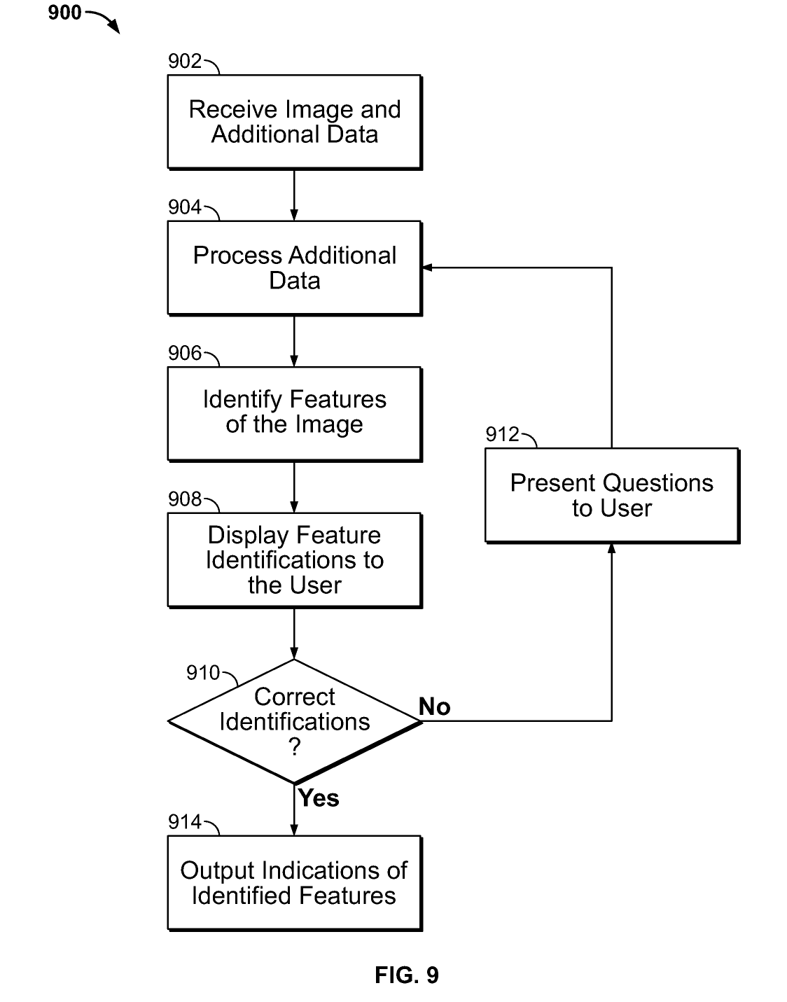

Media center 110 uses any identified features of the image, including the car and manufacturer in the billboard, to search for media assets to distribute to one or more of the user's media devices, such as media device 112. Media center 110 contains multiple media asset sources, including a collection of advertisements 114, from which media center 110 may select a set of car advertisements to distribute to the user. Media center 110 may select a set of general car advertisements or, more particularly, may select car advertisements specific to car 102 or advertiser name 104 in billboard 100 from the collection of advertisements 114. The identified advertisements are prepared by media center 110 and are distributed to media device 112 for presentation to the user. The process of identifying features in an image received by a media center and selecting media assets based on the features is described in more detail below with respect to FIGS. 3 and 9.

Media center 110 may access a user's account to facilitate identification of features in an image or selection of media assets to distribute. The user account can accumulate user information along with a history of past captured images and distributed assets. By accessing this information, media center 110 may be able to better identify a feature in a current image if it is similar to past images from the user. The media center 110 can use the history of past distributed assets to make an intelligent selection and avoid sending a user media assets that have already been previously distributed to that user. A user account may also be able to store user ratings for previously distributed assets, and the ratings can be used by media center 110 for intelligent selection of future assets.

Media center 110 may access the user account identified by information received from user device 108 to determine the media device to which selected media assets are to be distributed. The media account may include unique identifiers for the media devices, such as media device 112, that are registered to receive media assets through the user's media delivery system. Media center 110 may use these identifiers to distribute the selected media assets to the correct user and correct devices.

In certain implementations, media center 110 may distribute the selected advertisements directly to media device 112. The advertisements may be streamed from media center 110 to media device 112 as they are being presented to the user. For example, advertisements in a media delivery system may not be predetermined, such as for IPTV media or Internet media with forced periodic breaks for advertisements. In these systems, media device 112 may stream the selected advertisements to the user directly from media center 110 during each periodic advertisement break.

In some embodiments, information identifying the selected advertisements may be stored in a directory at media center 110. Media device 112 may then send a general request to media center 110 for an advertisement to present to the user during an advertisement break, and media center 110 may select and stream an advertisement based on the stored directory of advertisements selected for the user. In some embodiments, information identifying the relevant advertisements may be sent to and stored on media device 112. Media device 112 may then send a specific request for a certain advertisement based on the stored information to media center 110 to present to the user during an advertisement break. The advertisement selected by media center 110 or requested by media device 112 may also be selected based on a characteristic of the advertisement break in media presented on media device 112, such as the length of the break.

In certain implementations, media center 110 may distribute selected advertisements to storage 116 to be stored for later presentation to the user. In some embodiments, storage 116 may be integrated into media device 112. Storing the advertisements in storage 116 may eliminate the need for a constant streaming connection between media device 112 and media center 110 to present the advertisements to the user. This approach allows media device 112 to present the advertisements to the user at a later time without requiring a connection to media center 110 and may be preferable if, for example, media device 112 is a mobile device that does not maintain constant communication with media center 110.

In some embodiments, the advertisements may be transferred from media center 110 to storage 116 as soon as they are selected by media center 110. In some embodiments, the advertisements may be transferred gradually to storage 116, for example, in the vertical blanking interval (VBI) of media or in unused bandwidth of a data connection with media device 112. This gradual approach may be useful to avoid interfering with media presented on media device 112 that is streamed from media center 110 at the same time that the selected advertisements are transferred to storage 116.

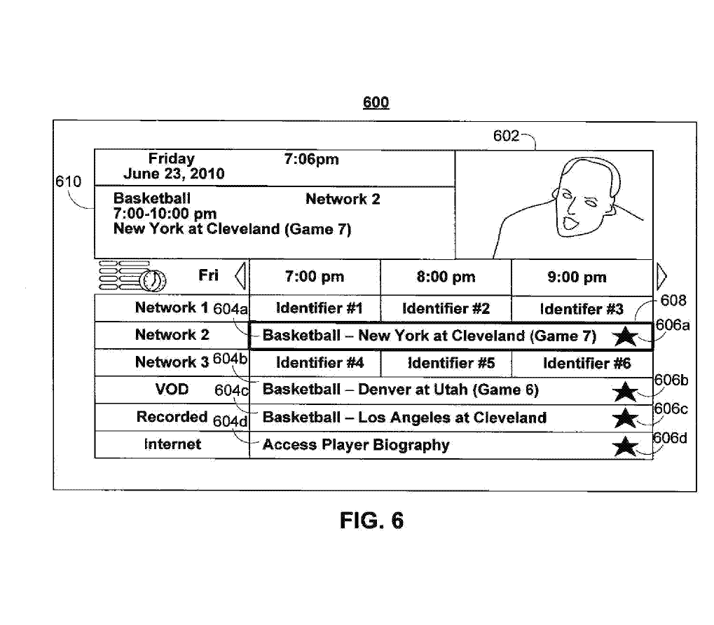

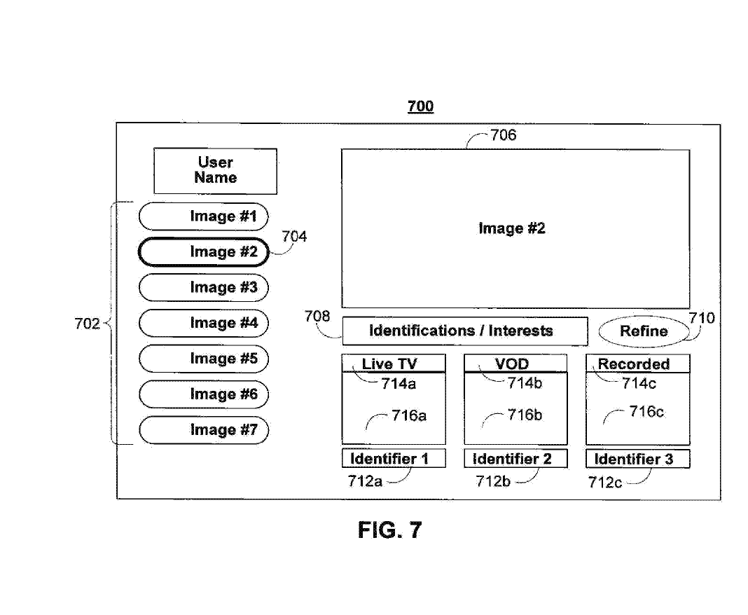

The media assets (i.e., the car advertisements) selected by media center 110 of FIG. 1 are presented to a user during media consumption as advertisements inserted into breaks in media viewed by the user, but selected media assets may be of any suitable type and may be presented to the user by any suitable approach. Alternate approaches for presenting selected media assets to a user are discussed in more detail below with respect to FIGS. 6 and 7.

The remote media delivery system of FIG. 1 is controlled by images captured by a user on a user device. The user can control media content delivered to the user's media devices by simply capturing an image, allowing the user to control the media delivery system from any location that the user device can be used.

A generalized embodiment of an illustrative user device for use in a media delivery system in accordance with the present invention is shown in FIG. 2. User device 200 captures and sends images and additional data that are used to control media distributed to a remote media device and may correspond, for example, to user device 108 of FIG. 1. User device 200 includes an integrated camera 202 that captures and sends images to processing circuitry 204. During use, the images captured by camera 202 include features that the user wishes to use to control media distributed by the user's media delivery system. The features may include a person, an object, an advertisement, text, a location, a landmark, a logo, a barcode, other unique identifier, or any other suitable feature that is of interest to the user.

An image captured by camera 202 is sent to processing circuitry 204. Processing circuitry 204 may be based on one or more microprocessors, microcontrollers, digital signal processors, programmable logic devices, or any other suitable circuitry. Processing circuitry 204 prepares the captured image for communication to a media center (e.g., media center 110 of FIG. 1) for use in selecting media assets for the user. Processing circuitry 204 may retrieve additional data that contains information associated with the image or the context in which the image was captured. Additional data associated with a captured image may include user input, location, date, time of day, type of user device with which the image is captured, or any other suitable data related to the image. Processing circuitry 204 may package the captured image with any available additional data for transmission to a media center. The data may be transmitted directly to the media center, or may be stored in memory included in storage 206 for later transfer.

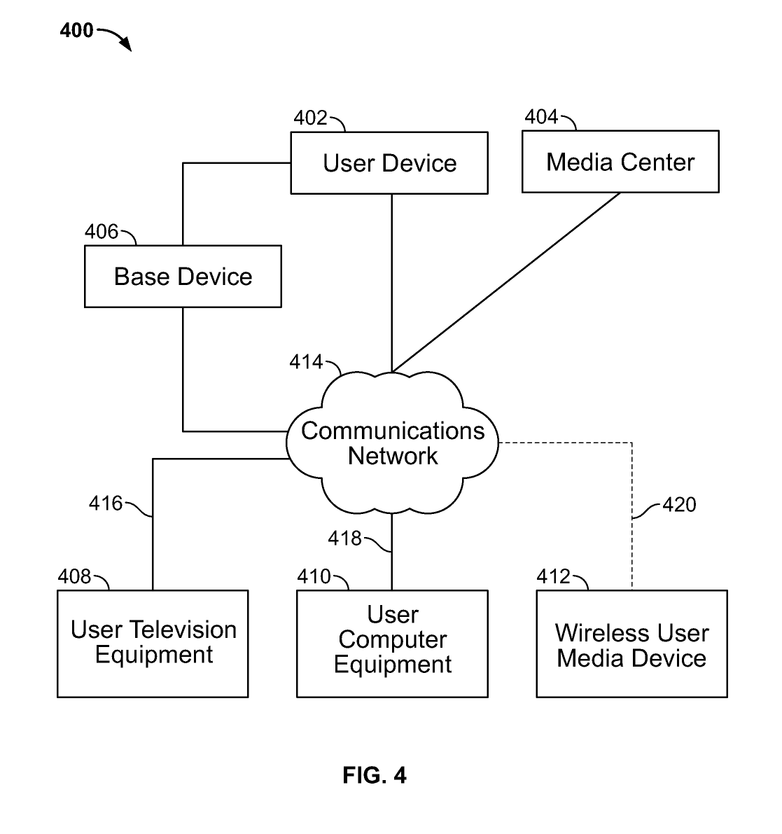

Memory (e.g. random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 206. Storage 206 may be used to store images captured by camera 202 or additional data related to the captured images. In some embodiments, processing circuitry 204 may obtain additional data from storage 206 to package with a captured image for immediate transmission to a media center if, for example, user device 200 maintains a constant communication connection with a media center. In some embodiments, processing circuitry 204 may package captured images and additional data and store the data packages in storage 206 for later transmission if, for example, user device 200 communicates with a media center periodically. In some embodiments, packaged images and supplemental data may be stored in storage 206 until user device 200 is connected to a base device (e.g., base device 406 of FIG. 4) to which the captured images and data are transferred.

User device 200 may also store user and user account information in storage 206. This identifying information stored in storage 206 can identify a user's account or prove authorization for the user and can be packaged with captured images and data sent to a media center. The information stored on user device 200 may also include a user's preferences or the devices to which a user's media is to be distributed.

A user may control user device 200 through user input interface 208. User input interface 208 may be any suitable user interface, such as a remote control, mouse, trackball, keypad, keyboard, touch screen, touch pad, stylus input, joystick, voice recognition interface, or any other suitable user input interface. User input received at user input interface 208 may control the settings of camera 202 or cause camera 202 to capture an image. User input received at user input interface 208 may also indicate user preferences associated with captured images and may affect the identification of features in an image or the selection of media assets based on the identified features. A user may also enter user input at user input interface 208 to respond to prompts or questions presented on user device 200, as is discussed below with respect to FIG. 9.

User input interface 208 may also be used to edit a captured image. A user may crop, enhance, rotate, or perform any other suitable image editing through user input interface 208. Features in a captured image may also be highlighted and targeted by a user through user input interface 208. The user may place an indication, such as a target, on a feature in an image that the user intends to use to control the media delivery system when the image is sent to a media center. These indications may be useful to focus the media center on selected aspects of the image and may facilitate more efficient feature identification and media asset selection.

User device 200 may communicate with a base device or a media center via communications circuitry 210. In some embodiments, communications circuitry 210 may support wired communication ports, including RCA, HDMI, DVI, S-Video, USB, coaxial cable, or any other suitable wired communications ports. In some embodiments, communications circuitry 210 may support wireless communications, including wireless area networks (e.g., 802.11b, 802.11g, or 802.11a), wireless personal area networks (e.g., Bluetooth or ZigBee), wireless metropolitan area networks (e.g., WiMax), wireless wide area networks, mobile devices networks (e.g., Global System for Mobile Communications, Personal Communications Service, or Digital Advanced Mobile Phone Service), cellular networks, or any other suitable wireless networks. Communications performed by communications circuitry 210 may include sending captured images and data to a base device or media center, sending and receiving commands from a base device or media center, receiving prompts or questions from a base device or media center, responding to received prompts or questions, or any other suitable communications.

Images and data from a user device (e.g., user device 200 of FIG. 2) are sent to and processed by a media center to control media distributed to media devices that are located remote from the user device. A generalized embodiment of an illustrative media center for use in a media delivery system in accordance with the present invention is shown in FIG. 3. Media center 300 selects media assets to distribute to a user based on received images and may correspond, for example, to media center 110 of FIG. 1. Media center 300 receives captured images and additional data at communications 302. Communications 302 may include a cable modem, an integrated services digital network (ISDN) modem, a digital subscriber line (DSL) modem, a telephone modem, a wireless modem, or any other suitable communications components. Images and data received at communications 302 may be received via wired or wireless communication.

Images and data received at communications 302 are sent to processor 304. Processor 304 coordinates the analysis of received images and data and the selection of media assets related to the images and data. Processor 304 uses information received from a user device to identify a user or otherwise associate a received image with a user account. The identified user account is retrieved and used for intelligent identification and selection. The account is also used to determine which user and media devices with which a received image is associated.

If any additional data is received with a captured image, processor 304 analyzes the additional data to extract useful information associated with the captured image. Useful information may include user input indicating what is in the image or what aspect of the image is of interest to the user. Useful information may also provide context, such as the location, date, or time of day, in which the image is captured, or useful information may identify the user device used to capture the image.

Captured images may be sent by processor 304 to image analyzer 306. Image analyzer 306 processes a received image to recognize and identify features of the image that may be of interest to a user and can be used to select media assets for the user. The features recognized by image analyzer 306 may include people, objects, advertisements, text, locations, landmarks, logos, barcodes, other unique identifiers, or any other suitable features. An image may be received with additional data that focuses image analyzer 306 on specific features of the image or otherwise affects the feature identifications and descriptions produced by image analyzer 306. The process of recognizing and identifying features of an image to use in locating media assets and information is discussed in more detail in U.S. patent application Ser. No. 12/780,489, filed on May 14, 2010, which is incorporated by reference herein in its entirety.

Any features of the captured image determined to be relevant are identified or described by image analyzer 306, and indications of the relevant features are sent from image analyzer 306 to processor 304. Indications output by image analyzer 306 may range from general descriptions to specific identifications of features in an image. For example, an image processed by image analyzer 306 may include an actor driving a car. Image analyzer 306 may recognize the presence of the actor and the car and may identify the actor and defining features of the car. Image analyzer 306 may send specific indications, such as the actor's name and the car manufacturer or model, as well as generic descriptions, such as the color of the car, to processor 304.

Processor 304 uses identified features of an image to access media sources 308 and select media assets related to the features. Media sources 308 may include conventional television media, pay-per-view media, on-demand media, Internet media, user-recorded media, advertisements, or any other suitable source of media assets. The media assets contained in media sources 308 may include media assets specific to the media delivery system in which media center 300 is used, such as video-on-demand media assets, media assets specific to the user transmitting captured images to media center 300, such as personally recorded media assets, or media assets that are generally available, such as Internet media available on public websites. A source of media assets included in media sources 308 may include an index or collection of metadata identifying the media assets in the source. This data can be useful in facilitating quick and efficient selection of media assets from the large amount of media available from media sources 308.

Processor 304 may create a search query using identified features of an image to select relevant media assets from media sources 308. The search query may be a listing of all identified features and additional data, or may be a filtered query for which processor 304 intelligently selects and/or combines a subset of the identified features and additional data to optimize the search. Combining features and data that are likely to be related, such as a logo and an advertiser name, may improve the search and easily identify relevant media assets, such as advertisements or purchasing information for the advertised company. Processor 304 may also create multiple queries for a single image, or for a single feature in an image. For example, processor 304 may create a specific primary query for an identified feature and more general secondary queries related to the identified feature. Using this approach, processor 304 may select media assets for the specific feature and broaden the search only if no relevant media assets are found for the specific feature. Once a search query is created, processor 304 may access metadata or indexes included in media sources 308 to select media assets to distribute to the user's media devices. A search engine may be integrated into media center 300 and may provide an interface between processor 304 and media sources 308 to facilitate searching for media assets (not shown).

The identified features used by processor 304 to select media assets from media sources 308 may be intelligently selected by processor 304. In one approach, processor 304 may treat all identified features of the captured image as interests of the user and search for media assets related to each feature. In another approach, processor 304 may select one or more features from the identified features that are more likely to indicate user interests and search for media assets based only on the selected features. For example, text identified in images is likely to be useful, and processor 304 may first attempt to select media assets based on recognized text from an image before using other identified features. In another approach, processor 304 may search for media assets by combining information extracted from additional data, such as user input, with features of the image identified by image analyzer 306. For example, an image including a logo and a barcode may be received along with the user input “logo”. Processor 304 may recognize the interest indicated by the user input and ignore any received indicators related to the barcode in the image and use only indicators for the logo in the image to select media assets for the user.

In addition to using the specific identified features, processor 304 may be able to determine one or more general interests of the user indicated by the captured image, and the general interests may be used to select media assets. Processor 304 may analyze the specific identified features and determine a general interest for the user into which the specific feature fits. This approach may be useful if processor 304 is unable to select media assets based only on the specific identified feature. For example, in the embodiment shown in FIG. 1, media center 110 may be unable to find any media assets for car 102 advertised in billboard 100. Media center 110 may use the identified car 102 to determine that the user is generally interested in cars, and may select available advertisements of other cars as relevant to the user.

Media assets selected for the user are distributed to one or more of the user's media devices by media distribution 310. Media distribution 310 may include circuitry for communicating over any suitable communications network, including the Internet, a mobile phone network, mobile device network, cable network, public switched telephone network, any other suitable type of communications network, or a combination of suitable communications networks. In a large distribution network, media center 300 utilizes user identification and account information to determine which devices in the network receive the distributed assets. The media center 300 may make this determination based on media devices identified as belonging to the user, as well as on user preference information regarding media distribution. User preference information may be especially useful when the user has multiple media devices of different types that have different media requirements.

Media distribution 310 processes and prepares selected media assets from media sources 308 for distribution to an appropriate media device. Preparing a selected media asset may include converting the format of a media asset to a format required by a media device, and media distribution 310 my include conversion circuitry capable of performing the format conversion. Media distribution 310 may package multiple media assets for distribution to the user if, for example, multiple assets or data related to the assets are presented to the user at one time, such as for an interactive list of the selected media assets. Media distribution 310 may stream media to a user device continuously, transfer media directly to the user device for future presentation, or transfer media to the user device gradually, as discussed above with respect to the distribution of media in FIG. 1.

The distribution of media assets selected for a user in the present invention depends on images captured by a user device (e.g., user device 200 of FIG. 2) being processed by a media center (e.g., media center 300 of FIG. 3) to control media distributed in a media delivery system. A generalized embodiment of an illustrative media delivery system in accordance with the present invention is shown in FIG. 4. Components of media delivery system 400 in FIG. 4 may correspond, for example, to like components shown in FIGS. 1-3. Media delivery system 400 uses images captured by a user to identify and provide media assets that are of interest to the user. A user with access to media delivery system 400 captures images with user device 402. A captured image is packaged with any available additional data and is sent to media center 404 over communications network 414. Media center 404 analyzes the image and any additional data received and identifies features of the image. Media center 404 uses the identified features to select media assets available through media delivery system 400 that are related to the images received from the user. The selected media assets are then provided to the user on a suitable media device, such as user television equipment 408, user computer equipment 410, or wireless user media device 412. For simplicity, these devices may be referred to herein collectively as media devices.

The media assets distributed by media delivery system 400 are based on images captured by user device 402. User device 402 may be any suitable device capable of capturing images, and may have substantially the same functionality as user device 200 discussed above with respect to FIG. 2. A user captures images with user device 402 that contain features that the user wishes to use to control media distributed to one or more of the user's media devices. Features used to control media distribution may include a person, an object, an advertisement, text, a location, a landmark, a logo, a barcode, other unique identifier, or any other suitable feature. The user may capture images to indicate a general interest, such as handbags, or a specific interest, such as a handbag made by a certain designer.

Additional data may be available for an image captured on user device 402. Additional data may be information about the context in which an image is captured or may be user input that can be used in directing the identification of features in the image or the selection of relevant media assets. User device 402 may automatically obtain additional data for an image, such as a location of user device 402 when an image is captured, which may be obtained from a location sensor in user device 402. The information automatically obtained may be known to the user, such as the time of day, or may be unknown to the user, such as precise GPS coordinates, and thus may provide useful supplemental information that the user is unable to provide manually. User device 402 may also present a prompt to the user to give the user an option to add user input for the image or send the image without any additional input. If the user chooses to add user input, user device 402 may present an interface to simplify user input entry, for example, by presenting a series of questions or categories to the user to classify the image. Questions and categories presented to the user may simplify interpretation of user input by a media center, such as media center 404, by eliciting answers from the user that are selected from groups of preset answers provided as options for each question.

An image captured by user device 402 and any available additional data are sent over communications network 414 to media center 404 for processing. Images may be sent from user device 402 to media center 404 directly if user device 402 is connected to media center 404 over a communications network. Images may be sent from user device 402 to media center 404 indirectly via base device 406 if user device 402 does not have communication capabilities or is not connected to media center 404 over a communications network. Base device 406 may be a computer, scanner, set-top box, hard drive, or any other intermediate device capable of communicating with the media center over communications network 414. In some embodiments, a captured image and additional data are sent from user device 402 to media center 404 as soon as the image is captured. In some embodiments, captured images and additional data are stored on user device 402, and groups of images and data are periodically transmitted to media center 404. In some embodiments, captured images and additional data are stored on user device 402 until they are transferred to base device 406. The transferred images and data are then sent to media center 404 from base device 406.

When an image is received at media center 404 from user device 402, media center 404 extracts identifying information to identify the user device 402 or user associated with the user device 402. This information tells media center 404 how to handle the received image and allows media center 404 to retrieve information on the user, the user's history, and the user's devices.

Images and additional data received at media center 404 are analyzed to identify features of the images and select media assets that relate to the identified features. Identified features of an image may include people, objects, advertisements, text, locations, landmarks, logos, barcodes, other unique identifiers, or any other suitable relevant feature. In some embodiments, more than one identifiable feature may be present in a captured image. Media center 404 may identify each feature and make a determination to use features together or to disregard one feature in favor of others. For example, media center 404 may recognize a logo and an advertiser name and may combine the two features to make an identification, since the advertiser name is likely to be associated with the logo. Media center 404 may also recognize the presence of a person and a building in an image and may disregard the building in favor of the person, since the building is more likely to be a background object and not of interest to the user.

Additional data received at media center 404 may also be used to identify features in a received image. In some embodiments, additional data may be sufficient to identify features of an image without performing any complex image analysis. For example, if media center 404 receives an image with additional data indicating that the image was captured at the location of a major landmark, it is likely that the landmark is the focus of the image. Media center 404 may assume the landmark is the focus of the image without performing any image analysis, or may simplify image analysis by comparing the image directly to a retrieved image of the landmark for verification. Information identifying the location from which the user captures or sends an image may be identified, for example, from location data obtained from a GPS sensor in user device 402. Media center 404 may also use a quick prompt to the user to verify that the image is the landmark, and my perform image analysis only if the user indicates that the landmark is not the intended focus of the image.

Media center 404 may combine information extracted from additional data with the identified features of the image to focus on certain features. This approach is especially useful when additional data for an image includes user input indicating a user's preference for media assets to be selected or a user's intended focus for an image. For example, a captured image may include a famous actor driving a car, and a user may send the user input “actor” with the image. Media center 404 may process the image and identify both the actor and the type of car. By combining the user input, “actor”, with the identified features, media center 404 may make a determination to focus on the identified actor and select relevant media assets for the actor rather than the car.

Media center 404 may use the identified features of the image and additional data to determine general interests of the user beyond the specific features. This approach may be useful for selecting media assets related not only to the specific feature captured by a user, but also media assets related to other interests of the user that can be inferred from the image but are not explicitly identified in the image. For example, if a user captures an image of a famous baseball player, media center 404 may identify the player's name and use the name to select media assets related to the individual player. Media center 404 may also determine a broad user interest in the player's team or, even broader, the sport of baseball in general. To determine the broader interests, media center 404 may enter the identified player's name as a search query to a search engine to locate supplemental information, such as the player's team or sport, to use in determining the general interests. This allows media center 404 to determine a spectrum of user interests that can be useful in providing the user with both media assets focused on the specific features of captured images and media assets related to broader user interests inferred from the specific features.

Media center 404 includes sources of media assets that are available to a user through media delivery system 400 and may be selected for distribution based on images received from a user. Sources of media assets included in media center 404 may be conventional television media, pay-per-view media, on-demand media, Internet media, user-recorded media, advertisements, or any other suitable types of media or video content. Media center 404 uses the identified features of the image to select media assets that are relevant to the user. The media center may use the identified features and any additional data to create a query to search the media assets and any medadata available for the media sources, as discussed above with respect to FIG. 3.

When multiple types of media assets are available in the collections, the types of media assets selected may depend on the identified features. For example, if an actor is identified in an image captured by the user, broadcast television shows in which the actor stars may be selected by media center 404. If an object with a logo is identified in a captured image, Internet shopping information for the object or similar objects may be selected, or advertisements for the company associated with the logo may be selected. If a location or landmark is identified in a captured image, a documentary about the history of the landmark available through a video-on-demand service or a pay-per-view service may be selected.

Media center 404 may select relevant media assets based on the media devices to which the media assets are distributed. Different types of media devices may require different formats of media assets, and media center 404 may identify only media assets available in the required format to be distributed to a given type of media device. For example, user computer equipment 410 may require media assets in MPEG format, which may not be compatible with user television equipment 408. Media center 404 may select only media assets that can be distributed in MPEG format for user computer equipment 410, and may not select any media assets in MPEG format for user television equipment 408. A user may also set different preferences for different types of user equipment, and media center 404 may select media assets based on the settings of a certain media device. For example, in some embodiments, a user may set a preference for video-on-demand media on user television equipment 408 and a preference for Internet media on user computer equipment 410. Media center 404 may recognize the set preferences and select relevant video-on-demand media assets to distribute to user television equipment 408 and relevant Internet media assets to distribute to user computer equipment 410.

Media center 404 may select relevant media assets based on the types of media distribution used to provide media to media devices 408, 410, and 412 in media delivery system 400. The media devices 408, 410, and 412 may be identified in the network 400 based on user account information received from user device 402. Types of media distribution used may include conventional broadcast distribution, satellite distribution, IPTV, distribution through an Internet browser, a video-on-demand server, a pay-per-view server, a personal recording server, or any other suitable type of distribution. The type of media distribution may dictate the type of media assets that can be distributed to a media device or the method by which media assets can be distributed. For example, if the media distribution for user television equipment 408 is conventional broadcast programming, media center 404 may not be able to distribute advertisements to user television equipment 408, since advertisements are already set for the broadcast programming. Media center 404 thus may not select advertisements to be distributed to user television equipment 408, or may select only advertisements that can be displayed through a media guide or other method utilized in the broadcast programming system that does not alter the broadcast programming. The types of media distribution used in media delivery system 400 may differ for different media devices in the system, and thus requirements may differ between media devices in the same media delivery system.

Media assets selected as relevant for a user by media center 404 are distributed to user television equipment 408, user computer equipment 410, wireless user media device 412, any other type of media device suitable for accessing media in media delivery system 400, or any combination thereof. User television equipment 408 may include a set-top box, an integrated receiver decoder (IRD) for handling satellite television, a television set, a digital storage device, a DVD recorder, a video-cassette recorder (VCR), a local media server, an Internet Protocol Television (IPTV) device, or any other suitable user television equipment. One or more of these devices may be integrated into a single device, if desired. User computer equipment 410 may include a personal computer, a laptop, a tablet, a personal computer television (PC/TV), a PC media server, a PC media center, or any sother suitable user computer equipment. Wireless user media device 412 may include a personal digital assistant (PDA), a mobile telephone, a smartphone, a portable video player, a portable music player, a portable gaming machine, or any other suitable wireless devices.

It should be noted that with the advent of television tuner cards for PCs and the integration of video into other devices, the lines have become blurred when trying to classify a device as one of the above devices. In fact, each of user television equipment 408, user computer equipment 410, and wireless user media device 412 may utilize similar features and, as a result, include flexibility with respect to the type of media available on the device. For example, user television equipment 408 may be Internet-enabled and allow for access to Internet media, while user computer equipment 410 may include a tuner and allow for access to conventional broadcast programming. Media may have the same layout on the various different types of media devices or may be tailored to the display capabilities of a specific media device. For example, on user computer equipment, media may be provided on a website accessed by a web browser. In another example, media may be scaled down for wireless user media devices.

In media delivery system 400, there is typically more than one of each type of media device, but only one of each is shown in FIG. 4 to avoid overcomplicating the drawing. In addition, each user may utilize more than one type of media device (e.g., a user may have a television set and a computer) and also more than one of each type of media device (e.g., a user may have a PDA and a mobile telephone and/or multiple television sets).

The media devices may be coupled to communications network 414. Namely, user television equipment 408, user computer equipment 410, and wireless user media device 412 are coupled to communications network 414 via communications paths 416, 418, and 420, respectively. Communications network 414 may be one or more networks including the Internet, a mobile phone network, mobile device network, cable network, public switched telephone network, any other suitable type of communications network, or a combination of suitable communications networks. Paths 416, 418, and 420 may separately or together include one or more communications paths, such as a satellite path, a fiber-optic path, a cable path, a path that supports Internet communications (e.g, IPTV), free-space connections (e.g., for broadcast or other wireless signals), any other suitable wired or wireless communications path, or a combination of such paths. Path 420 is drawn with dotted lines to indicate that, in the exemplary embodiment shown in FIG. 4, it is a wireless path, and paths 416 and 418 are drawn as solid lines to indicate that they are wired paths (although these paths may be wireless paths, if desired). Communications with the media devices may be provided by one or more of these communications paths, but are shown as a single path in FIG. 4 to avoid overcomplicating the drawing.

Media assets may be distributed to media devices using any suitable approach. In some embodiments, a media device may include a stand-alone media application that receives media via a data feed (e.g., a continuous feed, trickle feed, or data in the vertical blanking interval of a channel). Supplemental data associated with distributed media may be provided to the media device on a television channel sideband, in the vertical blanking interval of a television channel, using an in-band digital signal, using an out-of-band digital signal, or by any other suitable data transmission technique. Media may be provided to a media device with any suitable frequency (e.g., continuously, daily, a user-specified period of time, a system-specified period of time, in response to a request from a media device, etc.). In some approaches, media from media center 404 may be provided to media devices 408, 410, and 412 using a client-server approach. For example, a media application client residing on a media device may initiate sessions with media center 404 to obtain media when needed. Media center 404 may provide media devices 408, 410, and 412 the media application itself or software updates for the media application.

In some embodiments, media assets may be distributed to media devices (e.g., user television equipment 408, user computer equipment 410, or wireless media device 412) by streaming the media assets from media center 404 as they are presented to a user. A directory of media assets selected as relevant for a user may be maintained at media center 404 to facilitate streaming of the media assets to the media devices. The media directory may be continually updated with media assets selected as relevant each time an image is received and processed by media center 404. A media device may then send a general request for a media asset to stream to the user. The request may include the type of media asset, such as an advertisement, to be streamed. Media center 404 may select a media asset from the directory of relevant media assets and stream the selected media asset to the media device.

In some embodiments, media assets may be distributed to media devices by sending the media assets from media center 404 to be stored on a media device until they are presented to a user. The selected media assets may be distributed to media devices as soon as they are identified, or selected media assets may be distributed to media devices gradually if, for example, there is extra bandwidth available over a media distribution connection used to send a continuous media feed to a media device. The distributed media assets may be stored along with indications of the captured images, identified features, or general user interests to which they relate or the types of the distributed media assets to facilitate presentation to the user by the media device. This approach allows the distributed media assets to be presented to the user without requiring a connection to media center 404 after the media assets are distributed to the media device. Presentation to the user without a connection to media center 404 may be preferable for a media device that does not maintain a constant communication connection with media center 404, such as a mobile media device, and thus cannot always stream media assets from media center 404.

In some embodiments, identifiers for selected media assets may be presented to a user on a media device, and media assets may be distributed to the media device in response to a user selection of one or more of the relevant media assets. The identifiers may be presented as suggestions to the user provided through a standard user interface on a media device, and may be presented in response to a request received from the user for suggested media assets. A suggested relevant media asset selected by the user may then be streamed from media center 404 to the media device or sent to the media device for storage. Presenting selected relevant media assets to a user is discussed in more detail below with respect to FIGS. 6 and 7.

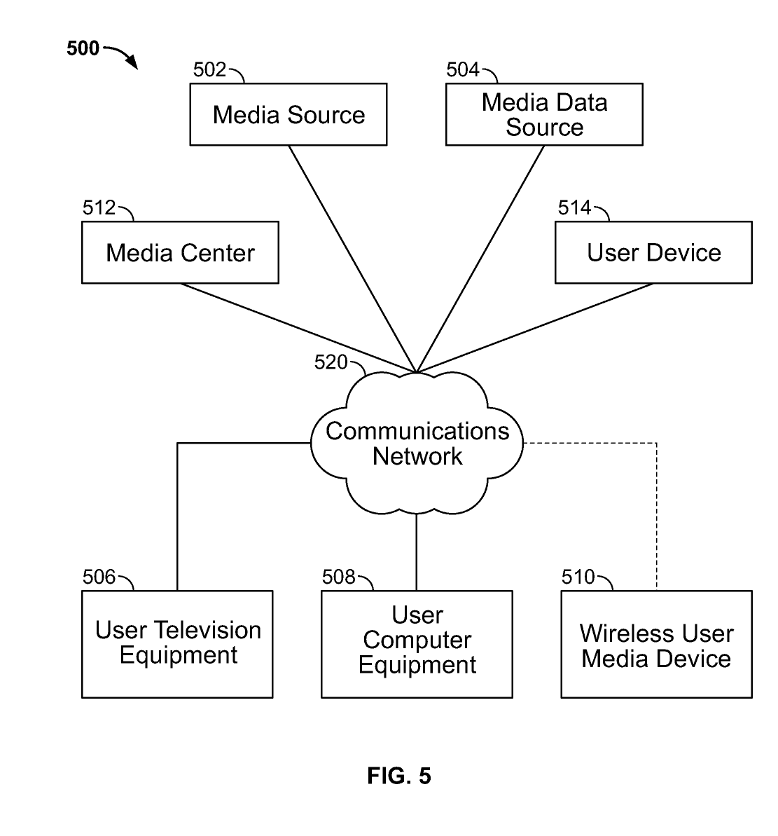

In media delivery system 400 of FIG. 4, media center 404 is the primary source of media distributed to media devices 408, 410, and 412. In some embodiments, however, the media delivery system of the present invention may be employed as a secondary media distribution source to supplement media distributed from a primary source. A generalized embodiment of an illustrative media delivery system employed as a secondary media distribution source in accordance with the present invention is shown in FIG. 5.

Media delivery system 500 of FIG. 5 provides media from primary media source 502 and data from primary media data source 504 to a user on a media device, such as user television equipment 506, user computer equipment 508, and wireless user media device 510. The media distributed to media devices 506, 508, and 510 is supplemented with media assets selected as relevant to a user by media center 512. Media center 512 provides supplementary media distribution by receiving images from user device 514 over communications network 520, selecting relevant media assets for a user based on the received images, and integrating the selected media assets with media normally distributed by primary media source 502 and primary media data source 504. In some embodiments, media center 512 may be integrated with primary media source 502 or primary media data source 504, or all three sources may be integrated into a single device.

Primary media source 502 may include one or more types of media distribution equipment including a television distribution facility, cable system headend, satellite distribution facility, programming sources (e.g., television broadcasters), intermediate distribution facilities and/or servers, Internet providers, on-demand media servers, or any other suitable media provider. Primary media source 502 may be the originator of media (e.g., a television broadcaster, a Webcast provider, etc.) or may not be the originator of media (e.g., an on-demand media content provider, an Internet provider of video of broadcast programs for downloading, etc.). Primary media source 502 may include cable sources, satellite providers, on-demand providers, Internet providers, or other providers of media. Primary media source 502 may also include a remote media server used to store different types of media (including video content selected by a user), in a location remote from any of the media devices.

Primary media data source 504 may provide media data, such as media listings, media-related information (e.g., electronic program guide information, broadcast times, broadcast channels, broadcast regions, media asset identifiers, media asset descriptions), metadata, ratings information (e.g., parental control ratings, critic's ratings, etc.), genre or category information, cast information, logo data (broadcasters' or providers' logos, etc.), media format (e.g., standard definition, high definition, MPEG, etc.), advertisement information (e.g., advertiser names, text, images, media clips, etc.), video-on-demand information, video source information, or any other suitable media information.

Media center 512 may supplement the distribution of media in media delivery system 500 by providing intelligent selection of media available to a user from primary media source 502 and primary media data source 504. Media center 512 communicates with primary media source 502 and primary media data source 504 over communications network 520 and may be able to access all media and data available through sources 502 and 504. Media center 512 my receive an image from user device 514 over communications network 520 and select media and data from sources 502 and 504 based on features of the received image. A directory of the selected media and data may be maintained on media center 512 and may be used to personalize and improve media distribution to media devices 506, 508, and 510 from sources 502 and 504.

Media center 512 may also include its own media sources and may provide access to additional media that is not available through primary media source 502 and primary media data source 504. Media center 512 may thus supplement the distribution of media to a user in media delivery system 500 with media assets not available from the user's primary media sources. For example, primary media source 502 and primary media data source 504 may contain all media available to a user through a standard cable television service provider, and media center 512 may include Internet media not available to the user through the cable television service provider. Media center 512 may thus supplement the distribution of media in media delivery system 500 not only by providing intelligent selection of media available through a user's service, but also by increasing the amount of media available to the user.

Media delivery system 500 coordinates distribution of media from sources 502 and 504 and media center 512 to provide the user with an improved media consumption experience. Media distributed to media devices 506, 508, and 510 may be coordinated and sent independently from sources 502 and 504 and media center 512. The coordination of media from these three devices may be controlled by one of sources 502 or 504, by media center 512, or by an external controlling device (not shown). The media distributed by the three devices may be integrated into a single presentation of media to a user on media devices 506, 508, and 510. For example, media delivery system 500 may be used to distribute video-on-demand media assets to a user from primary media source 502. Media center 512 may access the video-on-demand assets available from primary media source 502 and may select relevant on-demand assets as relevant to the user based on images received from user device 514. Media center 512 may maintain a directory of the selected on-demand assets for the user. When a user requests a display of available video-on-demand media assets, a list of categories of available video-on-demand assets may be provided by primary media data source 504. Media center 512 may supplement the list with a section of suggested video-on-demand assets from a directory of media assets selected based on past images captured by the user. When the user chooses a video-on-demand asset from the list, the selected media asset may be distributed to the user from primary media source 502.

Media distributed to media devices 506, 508, and 510 may also be coordinated and sent from only one of sources 502 and 504 and media center 512. For example, media center 512 may be the lone distributor of media to media devices 506, 508, and 510 through communications network 520. Media center 512 may access and select relevant media and data from sources 502 and 504, and may maintain a directory of the selected media and data, as discussed above. When a user requests media, media center 512 may gather the appropriate media assets and any data from sources 502 and 504 and distribute all media to the user devices over communications network 520. In such an embodiment, primary media source 502 and primary media data source 504 may not communicate at all over communications network 520, since all distribution to media devices 506, 508, and 510 is performed by media center 512.

In addition to presenting selected media assets directly to a user, a media delivery system may present identifiers for the selected media assets to a user. An illustrative media device screen for presenting identifiers for selected relevant media assets to a user in accordance with the present invention is shown in FIG. 6. Screen 600 may be presented to a user, for example, in response to a command from the user to browse media assets on a media device. Included in screen 600 are media assets identified as relevant based on image 602 that was captured by the user. The image includes a famous athlete, and the athlete, the athlete's team (Cleveland), and the athlete's sport (basketball) have been identified by a media center based on image 602.

Screen 600 includes both media assets that are and are not selected based on the identified features of image 602. Media assets represented by identifiers 604a, 604b, 604c, and 604d are selected based on image 602, and are displayed with icons 606a, 606b, 606c, and 606d, respectively, to indicate that these assets may be of particular interest to the user. The media assets represented by identifiers 604a, 604b, 604c, and 604d are selected as relevant because they are all related to basketball, the Cleveland team, the imaged athlete, or a combination thereof. Screen 600 also includes media assets on broadcast Networks 1 and 2 that are not selected based on image 602, and thus are not displayed with any special icons.

Screen 600 illustrates the ability of the present invention to select media assets of multiple types from multiple sources and present the assets to a user in a coordinated display. In addition to the live broadcast basketball game represented by identifier 604a, display 600 includes an on-demand basketball game represented by identifier 604b, a user-recorded basketball game represented by identifier 604c, and an Internet biography of the athlete in image 602 represented by identifier 604d.

A user may interact with screen 600 to receive information and make selections for the displayed media assets. A user may move highlight region 608 to receive more information or select one of the media assets. When a media asset identifier, such as identifier 604a, is highlighted, more information about the media asset may be presented in asset information region 610. The information included in asset information region 610 may include a media asset identifier, media asset type, time, network, plot summary, purchase price, media source, cast list, or any other suitable information related to a highlighted media asset. Additionally, if an identifier for a media asset selected based on a captured image is highlighted, the captured image that was used to select the media asset may be displayed. Image 602 is displayed in FIG. 6 because it was used to select the relevant media assets shown in screen 600, as discussed above, and because highlight region 608 is place on identifier 604a, which is one of the selected relevant media assets. In other embodiments, the region containing image 602 may be used to display other images or media, such as media that is being viewed by a user while browsing the media assets displayed in screen 600.

Although in FIG. 6 both media assets that are and are not selected based on captured images are shown, other embodiments may display only media assets selected based on captured images to a user. An illustrative media device screen for presenting a summary of captured images and selected relevant media assets to a user in accordance with the present invention is shown in FIG. 7. Screen 700 is presented to a user to provide a summary of images captured by the user and media assets selected as relevant to the user based on each captured image. Screen 700 may be presented to a user in response to a user request to view past captured images, or may be presented when the user turns on a media device, for example, to present images captured since the media device was last used. Screen 700 can be populated by identifying a user, for example, when a user logs into the system, and retrieving information for past images and assets from the user's account.

Screen 700 includes a list 702 of images that have been captured by the user and processed by a media center, such as media center 300 of FIG. 3. Although the images in list 702 are identified numerically, the identifiers may also be dates, user-entered names, or any other suitable identifying information associated with the images.

A user may select one of the identifiers or move highlight region 704 to display more information about the images. When an image is selected, such as Image #2 in screen 700, the selected image is displayed in region 706. Information about the image, such as a time, date, location, user device, user input, or any other suitable information, may be displayed along with the image in region 706. The features of the image in region 706 that have been identified by a media center are listed in region 708. Any user interests that may be determined based on the specific identifications, such as more general or categorical interests, may also be listed in region 708. Each listed identification and interest may be associated with a target placed on the image in region 706, and the user selection of one of the identifications or interests may highlight the target or targets associated with the selected identification or interest (not shown). If one or more of the identifications or interests listed in region 708 are inaccurate, the user may select option 710 to refine the data by adding, deleting, or changing the identifications or interests.

Media assets that have been selected as relevant for the user based on the highlighted image are displayed in screen 700. Identifiers 712a, 712b, and 712c represent three selected media assets. More or fewer than three media assets may be displayed for a selected image, but only three are shown in FIG. 7 for simplicity. The displayed media assets are classified by asset types 714a, 714b, and 714c. Although in FIG. 7, all three displayed assets are of different types, two or more of the displayed assets may be of the same type. In addition, there may be more media assets of asset types 714a, 714b, and 714c that are selected as relevant based on the image displayed in region 706 that are not displayed in screen 700. In response to a user selection of one of asset types 714a, 714b, and 714c, display 700 may be changed to display only relevant media assets of the selected type (not shown). Summary regions 716a, 716b, and 716c may provide further details about the media assets represented by identifiers 712a, 712b, and 712c. The details may be program information similar to the information shown in asset information region 610 of FIG. 6. The detail displayed may also be a screen shot of a media asset, and user selection of the screen shot may cause a short clip from the selected media asset to be played.

In addition to the information shown in FIG. 7, screen 700 may be used to provide other information and data related to a user's captured images and identified interests. Screen 700 may allow the user to interactively change this information or manage captured images by modifying or deleting captured images. In some embodiments, information related to alternate uses of the media delivery system of the present invention may be presented in the summary screen of FIG. 7. For example, a promotion may be available through the media delivery system supporting the media device on which screen 700 is displayed. The promotion may be a contest to capture a certain number of images of a given target, such as a famous actor. The promotion may offer rewards to users, such as credits for free video-on-demand purchases or access to exclusive movie trailers based on the number of images the user has captured of the target. These examples are discussed only for the purpose of illustration, and other applications of the media delivery system are within the scope of the present invention.

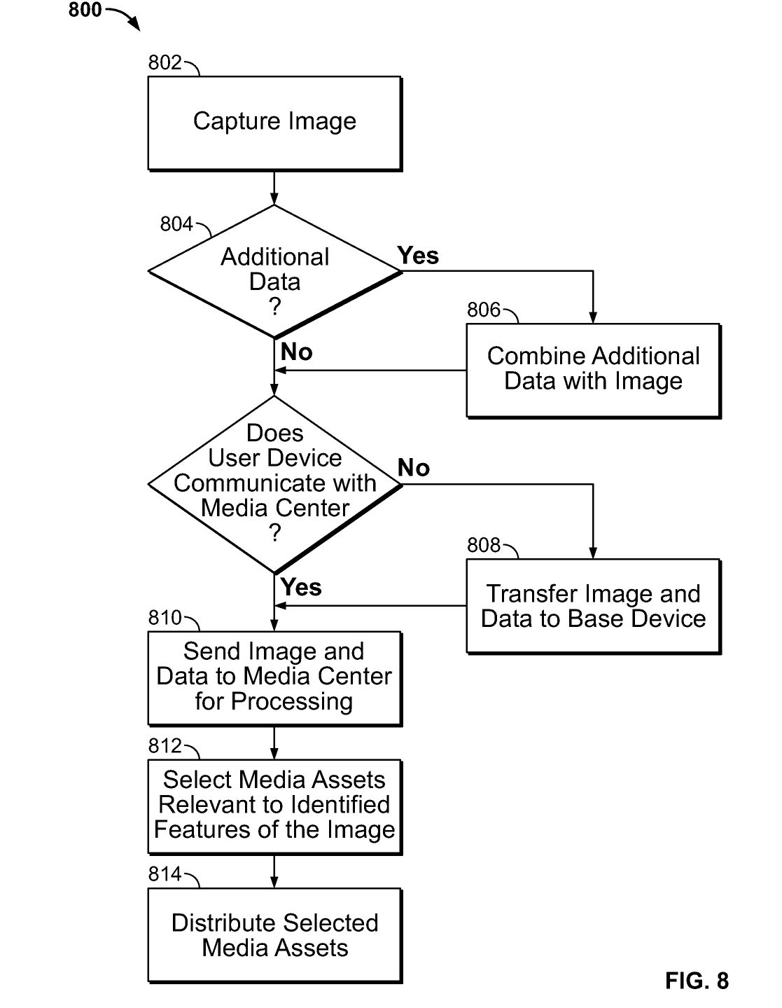

FIGS. 8 and 9 show illustrative flow diagrams for processes related to the present invention. Steps in the processes may be added, omitted, or performed in any order without departing from the scope of the invention.

FIG. 8 shows a flow chart 800 of illustrative steps involved in distributing media assets to a user's media devices based on images received from the user in accordance with the present invention.

A user captures an image on a user device (e.g. user device 200 of FIG. 2) at step 802. The image captured by the user includes one or more features that indicate an interest of the user. The features may include people, objects, advertisements, texts, locations, landmarks, logos, barcodes, other unique identifiers, or any other suitable relevant feature. The user device may allow the user to edit, crop, or add indicators to the image in order to direct focus to the features of the image that the user is interested in.

The user device on which the image is captured determines at step 804 whether there is additional data available to be used with the captured image. Additional data that provides information related to the context in which the image was captured may be data automatically obtained by the user device. Additional data automatically obtained by the user device may include a location, date, time of day, type of user device, or any other suitable information related to the context in which an image is captured. The additional data automatically obtained may include both information that the user is and is not aware of. Additional data may be obtained at the time the image is captured, for example, for the time of day or the location of the user device. Additional data may also be retrieved from storage on the user device, for example, to identify the type of user device with which the image is captured.

Additional data may include user input received on the user device when the image is captured. User input may include indications of the features of the image the user is interested in, the user's preferences of types of media assets identified based on the image, or any other user input to be used in identifying features of the captured image and determining interests of the user. The user device may provide a prompt to the user to give the user an option to enter user input for the image. The user device may then present the user with preset questions and multiple choice answers. The preset questions and answer options can be used to ensure that useful information is received from the user, for example, to classify the contents of the image or types of media assets likely to be relevant to the image. In addition to the preset questions, the user device may also present the user with a miscellaneous option to provide any other input the user considers relevant.

If additional data is available at step 804, the data is combined and packaged with the captured image at step 806. The additional data and captured image may be packaged for immediate transmission to a media center (e.g., media center 300 of FIG. 3). The additional data and captured image may also be packaged and stored in memory (e.g., in storage 206 of FIG. 2) on the user device for future transmission during a periodic upload to a media center or for transfer to a base device.

User or device information is also packaged with the captured image and additional data for transmission. The identifying data allows a media center receiving the transmission to recognize the user and retrieve any needed data relating to the user, the user's search history, or the user's different devices.

If the media device is not capable of communicating to the media center, the captured image and any additional data are transferred to a base device at step 808. The base device may be a computer, scanner, set-top box, hard drive, or any other intermediate device capable of communicating with the media center. For example, if a standard digital camera is used to capture images of a user's interests, the camera may not be able to send the images directly to the media center over a communications network. The images may be transferred to a base device, such as a computer, over a wired connection, such as a USB cable, before being sent from the base device to the media center over a communications network. The user may enter any user input in addition to the input entered at step 806 into the base device to be packaged and sent with the captured image.

The image and additional data are sent to a media center from the user device or the base station for processing at step 810. Images and additional data are processed by the media center to identify features of the images. The identified features and information are output to be used to select media assets to distribute to the user. The process of receiving images and data at a media center and identifying features of the images to be used in selecting media assets for a user is discussed in more detail below with respect to FIG. 9.

The identified features of the captured image are used at step 812 to select media assets that are likely to be of interest to the user. The media center accesses a collection of media sources (e.g., media sources 308 of FIG. 3) that include a variety of media assets of different types. The media sources may include metadata or indexes containing descriptive data for the media assets in the sources, and a search engine may provide an interface between the media center and the large amount of data contained in the sources. The media center may create a search query based on the identified features of the image and any relevant additional data to select media assets from the media sources to distribute to the user. The media center may process the identified features and additional data to combine, omit, or highlight certain features and data and produce an optimized search query. The media center may also produce more than one search queries, ranging from broad to specific, to be used to select relevant media assets. Media assets selected for the user are then retrieved for distribution or added to a directory of relevant media assets in the media center for future distribution.

Media assets that are relevant to the user's interests are distributed to one or more of the user's media devices at step 814. The media devices to which assets are distributed are identified based on user information received with the captured image and information retrieved from the user's account. In some embodiments, the relevant media assets are distributed to a media device by streaming the media assets from the media center as they are presented to the user. In some embodiments, the relevant media assets are distributed to storage associated with a media device directly via an independent data transmission connection for future presentation to the user on the media device. In some embodiments, the relevant media assets are distributed to storage associated with a media device gradually over an occupied data transmission connection (e.g., in the vertical blanking interval of a media connection or in extra bandwidth of a data transmission connection). The relevant media assets may be distributed to the media device as soon as they are selected by the media center or, alternatively, may be identified in a directory at the media center and distributed to the media device at a later time, for example, in response to a future request received from the media device.

FIG. 9 shows a flow chart 900 of illustrative steps involved in identifying features of an image received at a media center to be used to control media assets distributed to a user's media devices in accordance with the present invention.

A captured image and any additional data associated with the image is received by a media center (e.g., media center 300 of FIG. 3) at step 902. The image and data may be received from a user device or a base device, and may correspond to the image and data that is combined and packaged at step 806 of FIG. 8 and received by a media device at step 810 of FIG. 8.

Any additional data received by the media center is processed at step 904. Additional data may be processed before the received image to streamline the identification of features of the image if, for example, the features of the image can be identified using only the additional data and, thus, more complicated image recognition analysis may be avoided. The additional data may also be interpreted to extract information associated with features of the image or the user's intended targets for identifying features of the image. Any useful extracted information may be associated with either a specific targeted feature or with the whole image, and may be passed to an image analyzer to be used for recognition and identification of image features.

Features of the captured image are identified at step 906. The features of the image may be initially targeted by recognizing features in the image which may be identifiable, such as faces, text, objects, landmarks, logos, barcodes, or other recognizable objects. The recognizable features may then be identified by performing image comparison to known images, or by performing pattern recognition of the captured image. Information extracted from additional information received with the image may be utilized to minimize the number of potentially matching images used for comparison, and thus may greatly increase the efficiency and effectiveness of the image analysis. Data associated with images determined to be positive matches for features of the captured image is used to output an identification of the features.

Potential identifications for features of the captured image are presented to the user on the user device or base device at step 908. A list of the identified features may be presented to the user, or the captured image may be presented with indications of the identified features included on the image as an overlay. The user may select one or more of the displayed identified features, and the user device or base device may present the user with additional information related to the selected features, for example, by performing an Internet search for information about the features.

The user device or base device prompts the user to accept or reject the displayed identifications for the features of the image at step 910. If the user indicates that one or more of the identifications are incorrect, the user device or base device presents a set of questions to the user at step 912 to obtain additional information to use in performing a new identification of the incorrect features. The questions presented at step 912 may be similar to the preset questions and multiple choice answers discussed above with respect to FIG. 8, and may be especially useful if the user declines to provide any initial user input at the time the image is captured. The new user input is added to the original image and captured image, and the data and image are processed again at steps 904 and 906 to attempt to identify the image features.

Once confirmation is received from the user that all feature identifications are acceptable, indications of the identified features are output at 914 to be used to select media assets for the user. Indications for all identified features may be output at step 914, or features may be omitted, combined, or used to determine user interests beyond the specific identification of a feature to improve selection of media assets.

Feature identifications may be omitted at step 914 if the media center decides that a first feature is much more likely to be useful to select media assets for the user than a second feature, and inclusion of the second feature may decrease the ability of the system to accurately select relevant media assets. This decision may be made based on a general trend for images captured by all users, a detected trend for images captured by a specific user, additional data that was provided with the captured image, any other suitable criteria, or a suitable combination thereof. For example, if an identification of a logo is received along with an identification of a person for a single image, the logo may be omitted and only indications for the identified person may be output. This omission may be made based on a general trend across all users indicating that people are much more likely to be of interest than logos, based on a trend for a specific user indicating that people are usually of interest to the user, based on user input, such as “person”, received with the image, based on any other suitable criteria, or based on any suitable combination thereof.

Feature identifications may be combined at step 914 if the media center decides that the identified features are likely to be related. For example, in the embodiment of FIG. 1, the media center may receive identifications of car 102, advertiser name 104, and logo 106. The media center may decide that all three of these features are likely to be related, since the identifications include a model of car 102, a car manufacturer indicated by advertiser name 104, and a car company associated with logo 106. The media center thus may output a single set of indications based on all three features instead of independent sets of indications each tied to a specific feature, and thus may simplify the process of selecting relevant media assets based on the captured image.

Feature identifications may be used to determine user interests beyond the narrow identifications of features contained in the image if the media center decides that the features are likely to be indicative of broader interest categories into which the identified features belong. A single feature identification may be used to determine a wide spectrum of user interests, ranging from specific to broad, that may be useful in identifying a variety of relevant media assets for the user. For example, in the embodiment of FIG. 1, the media center may use received information and identified features of an image of billboard 100 to determine that the user has a general interest in cars, and a specific interest in the car model or manufacturer identified. This allows the media center to provide user interests that can be used to make intelligent selections of relevant media assets, such as selecting advertisements for any car as generally relevant to the user and selecting car advertisements for the identified manufacturer or model as specifically relevant and more relevant than car advertisements for other models or manufacturers.

The foregoing is merely illustrative of the principles of the present invention, and various modifications can be made by those skilled in the art without departing from the scope and spirit of the invention.

1. A method for distributing a media asset to a user, the method comprising:
receiving an image from a user;
determining a first interest of the user based on the received image;
selecting a media asset based on the determined first interest; and
distributing the selected media asset to a media device associated with the user.

2. The method of claim 1, further comprising creating a search query based on the first interest, wherein the selecting comprises selecting the media asset based on the search query.

3. The method of claim 1, wherein the determining comprises determining the first interest further based on user input received from the user.

4. The method of claim 1, wherein the determining comprises determining the first interest based on a feature identified in the received image.

5. The method of claim 4, further comprising:
creating a search query based on the identified feature; and
performing a search for supplemental information based on the search query, wherein the supplemental information is used to determine the first interest.

6. The method of claim 4, wherein the selecting comprises selecting the media asset based on the first interest in response to determining that no media assets can be selected based on the identified feature.

7. The method of claim 1, further comprising determining a second interest of the user based on the received image, wherein the selecting comprises selecting a media asset based on both the first and second interests.

8. The method of claim 1, further comprising determining a second interest based on the received image, wherein:
the first interest is a general interest;
the second interest is a specific interest; and
the selecting comprises selecting the media asset based on the first interest in response to determining that no media assets can be selected based on the second interest.

9. A system for distributing a media asset to a user, the system comprising:
a media center configured to:
receive an image from a user;
determine a first interest of the user based on the received image;
select a media asset based on the determined first interest; and
distribute the selected media asset to a media device associated with the user.

10. The system of claim 9, wherein the media center is further configured to:
create a search query based on the first interest; and
select the media asset based on the search query.

11. The system of claim 9, wherein the media center is further configured to determine the first interest further based on user input received from the user.

12. The system of claim 9, wherein the media center is further configured to determine the first interest based on a feature identified in the received image.

13. The system of claim 12, wherein the media center is further configured to:
create a search query based on the identified feature; and
perform a search for supplemental information based on the search query, wherein the supplemental information is used to determine the first interest.

14. The system of claim 12, wherein the media center is further configured to select the media asset based on the first interest in response to determining that no media assets can be selected based on the identified feature.

15. The system of claim 9, wherein the media center is further configured to:
determine a second interest of the user based on the received image; and
select a media asset based on both the first and second interests.

16. The system of claim 9, wherein:
the media center is further configured to determine a second interest based on the received image;
the first interest is a general interest;
the second interest is a specific interest; and
the media center is further configured to select the media asset based on the first interest in response to determining that no media assets can be selected based on the second interest.

17-24. (canceled)
